(19) United States
(12) Patent Application Publication
(10) Pub. No.: US 2018/0008978 A1
(43) Pub. Date: Jan. 11, 2018

(54) READY-TO-USE DEVICE FOR MOUSE BONE MARROW CELLS ISOLATION

(71) Applicant: Jyoti Balhara, Hamilton (CA)

(72) Inventor: Jyoti Balhara, Hamilton (CA)

(21) Appl. No.: 15/646,212

(22) Filed: Jul. 11, 2017

Related U.S. Application Data
(60) Provisional application No. 62/360,482, filed on Jul. 11, 2016.
(60) Provisional application No. 62/514,989, filed on Jun. 5, 2017.

(51) Int. Cl. B01L 3/00

(52) U.S. Cl. CPC B01L 3/5082; B01L 2400/0409; B01L 2200/0652; B01L 2300/0832

(57) ABSTRACT

The present invention is, in combination, a bone marrow isolation tube and a centrifuge tube. The combination includes a centrifuge tube which defines a tube cavity and includes an upper cylindrical section connected to a lower tapered section which terminates at a bottom reservoir. The isolation tube is adapted to be received within the centrifuge tube cavity. The isolation tube includes a body with a tubular shaped outer surface wherein the interior of the isolation tube defines a lumen which includes an upper cylindrical lumen section and a lower conical lumen section terminating at an orifice. The isolation tube includes at least one wing extending radially outward from the outer surface of the isolation tube. The wing is configured to make contact with the interior surface of the centrifuge tube and wedge the isolation tube into the tapered section of the centrifuge tube during centrifuging. The present invention is also, in combination, a bone marrow isolation tube and a centrifuge tube. The centrifuge tube defines a tube cavity and includes at least two support members defining an insertion space and attached to the interior surface in an upper cylindrical section, the upper cylindrical section connected to a lower tapered section which terminates at a bottom reservoir. The isolation tube is adapted to be received within the insertion space with a flange that is configured to make contact with the support members of the centrifuge tube thereby wedging the isolation tube into the insertion space of the centrifuge tube during centrifuging.

This application claims priority from regularly filed U.S. provisional patent application 62/360,482 filed by Jyoti Balhara on Jul. 11, 2016 under the title: READY-TO-USE DEVICE FOR MOUSE BONE MARROW CELLS ISOLATION as well as regularly filed U.S. provisional patent application 62/514,989 filed on Jun. 5, 2017 by Jyoti Balhara under the title: READY-TO-USE DEVICE FOR MOUSE BONE MARROW CELLS ISOLATION.

### FIELD OF THE INVENTION

The present invention relates to methods and devices for isolating bone marrow cells from mouse bone.

### BACKGROUND OF THE INVENTION

Bone marrow cells from murine bone are frequently used in immunological and stem cell research. The current conventional method of collecting bone marrow cells involves many time-consuming steps including: harvesting the tibia and femur of the mouse, cleaning the bone by removing the attached skin and muscle tissue, using a fine gauge needle to flush the marrow from the bone into a microcentrifuge tube and then microcentrifuging the flushed marrow to separate the bone marrow cells.

Flushing the bone marrow introduces unnecessary risks to the user due to the possibility of the user accidentally sticking or poking his or herself with the needle while trying to place the needle in the correct position to flush the bone marrow. Accidental needle pokes are of great concern to the health and safety of researchers as researchers can be exposed to infectious diseases, harmful chemicals or other biohazards.

The present invention removes the requirement for the flushing step in the current conventional method of collecting bone marrow tissue from murine bone resulting in a safer and more efficient method for the user.

### SUMMARY OF THE INVENTION

The present invention is a bone marrow isolation tube and a centrifuge tube, the combination includes a centrifuge tube which defines a tube cavity with an interior surface and includes an upper cylindrical section, connected to a lower tapered section which terminates at a bottom reservoir. The isolation tube is adapted to be received within the centrifuge tube cavity and includes a body with a tubular shaped outer surface wherein the interior of the isolation tube defines a lumen which includes an upper cylindrical lumen section and a lower conical lumen section terminating at an orifice.

The isolation tube furthermore includes at least one wing extending radially outward from the outer surface of the isolation tube wherein the wing is configured to make contact with the interior surface of the centrifuge tube thereby contacting and wedging the isolation tube into the tapered section of the centrifuge tube during centrifugation.

The wing includes an upper wing section for contacting with the upper cylindrical section of the centrifuge tube, and a lower tapered wing section adapted to wedge and contact with the interior surface of the lower tapered section of the centrifuge tube thereby maintaining the isolation tube at a pre-selected capture distance from a centrifuge tube bottom. Furthermore, the wing includes an upper abutment area for contacting with the upper cylindrical section of the centrifuge tube, and a lower abutment area for contacting with the lower tapered section of the centrifuge tube thereby maintaining the isolation tube at a pre-selected capture distance from a centrifuge tube bottom.

The upper wing section includes an upper abutment area for contacting with the upper cylindrical section of the centrifuge tube, and the lower tapered wing section includes a lower abutment area for contacting with the interior surface of the lower tapered section of the centrifuge tube thereby maintaining the isolation tube at a pre-selected capture distance from a centrifuge tube bottom.

Preferably, the isolation tube includes at least three identical wings spaced around the outer surface of the isolation tube thereby providing three lower abutment areas for contacting and wedging the isolation tube into the tapered section of the centrifuge tube during centrifuging. The orifice is dimensioned to allow bone marrow cells to pass through but not cortical bone. The capture distance is selected to hold the bone marrow cells and any liquid media.

Preferably the isolation tube received within the tube cavity of the centrifuge tube defines a gap between the outer surface of the isolation tube and the interior surface of the centrifuge tube.

An alternate embodiment of the present invention is a centrifuge tube which defines a tube cavity which has an interior surface and includes at least two support members defining an insertion space and attached to the interior surface in an upper cylindrical section, the upper cylindrical section connected to a lower tapered section which terminates at a bottom reservoir. Furthermore, there is an isolation tube adapted to be received within the insertion space that includes a body with a tubular shaped outer surface wherein the interior of the isolation tube defines a lumen which includes an upper cylindrical lumen section and a lower conical lumen section terminating at an orifice. The isolation tube includes a flange above the upper cylindrical section wherein the flange is configured to make contact with the support members of the centrifuge tube thereby contacting and wedging the isolation tube into the insertion space of the centrifuge tube during centrifuging.

Preferably the flange includes a bottom flange surface that rests on an upper abutment section of the support members and walls at the upper cylindrical lumen section that contact with an insertion abutment section of the support members adapted to wedge the isolation tube in insertion space thereby maintaining the orifice at a pre-selected capture distance from a centrifuge tube bottom.

Preferably the centrifuge tube includes four identical support members spaced around the interior surface of the upper cylindrical section thereby providing four upper abutment sections and four insertion abutment sections for contacting and wedging the isolation tube into the insertion section of the centrifuge tube during centrifuging.

The orifice is dimensioned to allow bone marrow cells to pass through but not cortical bone and the capture distance is selected to hold the bone marrow cells and any liquid media.

### BRIEF DESCRIPTION OF THE DRAWINGS

The present will now be described by way of example only with reference to the following drawings in which:

FIG. 1 is a top end view of the bone marrow isolation tube.

FIG. 2 is a side elevation view of the bone marrow isolation tube.

FIG. 3 is a top front perspective view of the bone marrow isolation tube.

FIG. 4 is a top end plan view of the bone marrow isolation tube inserted in a microcentrifuge tube.

FIG. 5 is a side elevation view of the bone marrow isolation tube inside a microcentrifuge tube.

FIG. 6 shows two microcentrifuge tubes with bone marrow cells collected using the present invention on the left and the conventional flushing method on the right.

FIG. 7A is a schematic representation of an alternate embodiment of the bone marrow isolation tube in use with a microcentrifuge tube.

FIG. 7B is a schematic top perspective view of the alternate embodiment shown in FIG. 7A of a microcentrifuge tube shown together with support members projecting inwardly from the wall of the microcentrifuge tube

FIG. 7C is a top schematic perspective view of an Microcentrifuge microcentrifuge tube with an isolation tube deployed therein wherein an upper flange of the isolation tube is resting upon support members thereby holding the isolation tube institute within the Microcentrifuge/microcentrifuge tube.

FIG. 8 is a schematic cross-sectional view of an isolation tube taken along line 8-8 shown in FIG. 11.

FIG. 9 is a schematic bottom side perspective view of an isolation tube.

FIG. 10 is a side elevation view of the isolation tube shown in FIG. 9.

FIG. 11 is a top end plan view of the isolation tube shown in FIG. 9.

FIG. 12 is a side view of an Microcentrifuge or also called a microcentrifuge tube having deployed there in an isolation tube within the Microcentrifuge tube cavity wherein the Microcentrifuge is shown transparently.

FIG. 13 is a side view of an Microcentrifuge or also called a microcentrifuge tube having deployed there in an isolation tube within the Microcentrifuge tube cavity wherein the Microcentrifuge is shown transparently.

FIG. 14 is a cross-sectional view taken along lines 14-14 shown in FIG. 13 wherein the Microcentrifuge tube and the isolation tube are shown in the longitudinal cross-sectional form.

FIG. 15 is a schematic isometric/perspective view of the Microcentrifuge tube having deployed there in the isolation tube wherein the Microcentrifuge tube is shown transparently

FIG. 16 is a top plan view of the lid of the Microcentrifuge tube

FIG. 17 is a top plan view of the lid of the Microcentrifuge tube showing an isolation tube deployed therein wherein the Microcentrifuge tube is shown transparently.

### DETAILED DESCRIPTION OF THE PREFERRED EMBODIMENTS

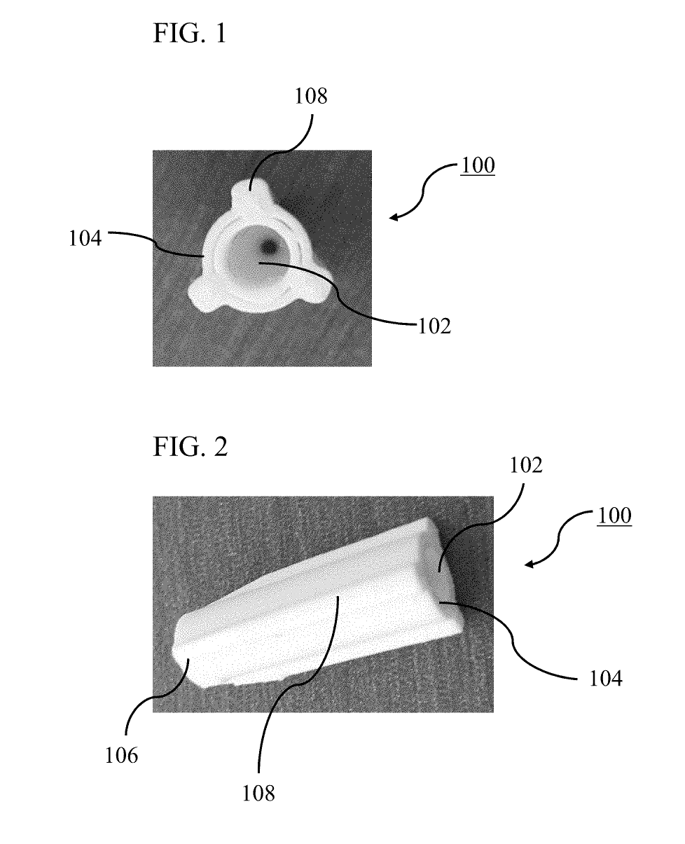

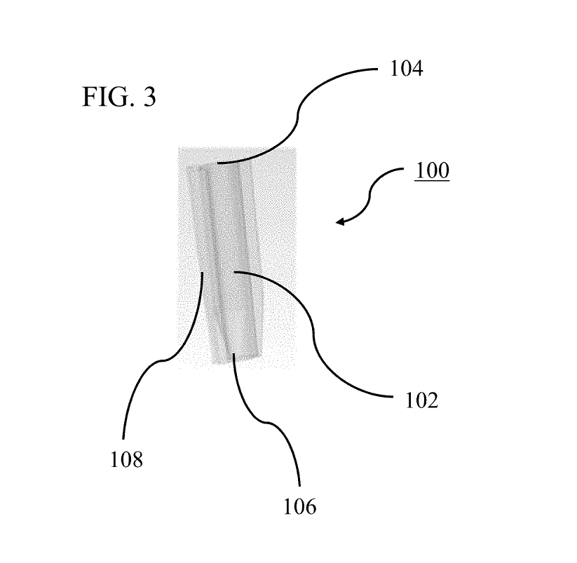

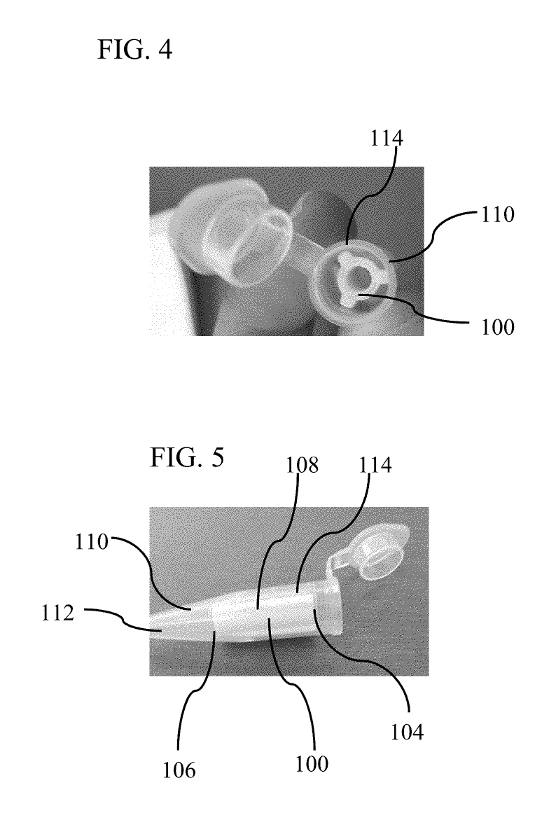

Referring first to FIGS. 1, 2, and 3 which show a bone marrow isolation tube 100. Bone marrow isolation tube 100 has a lumen 102 that has top diameter 104 of 4 mm of and that narrows at the bottom with bottom diameter 106 of approximately 1 mm. Bone marrow isolation tube 100 has three wings 108 that allows bone marrow isolation tube 100 to sit inside a 1.5 ml microcentrifuge tube 110 (shown in FIGS. 4 and 5).

Referring now to FIGS. 4 and 5 which show bone marrow isolation tube 100 inserted in a standard 1.5 mL microcentrifuge tube 110. Wings 108 abut walls 114 of microcentrifuge tube 110 to hold bottom diameter 106 above reservoir 112.

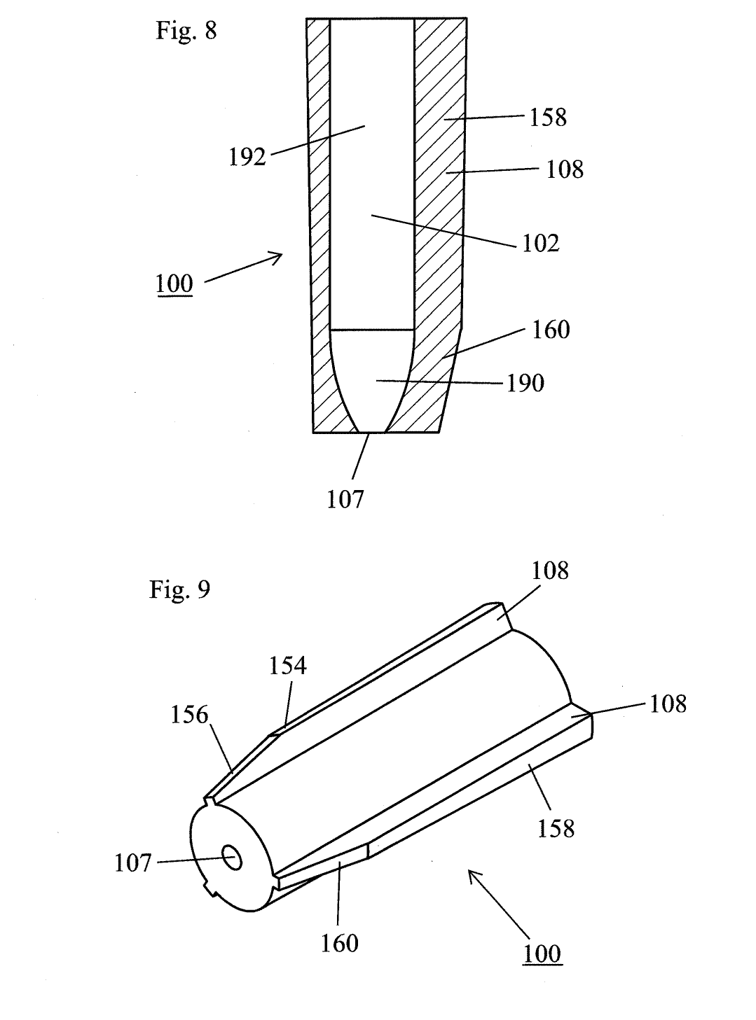

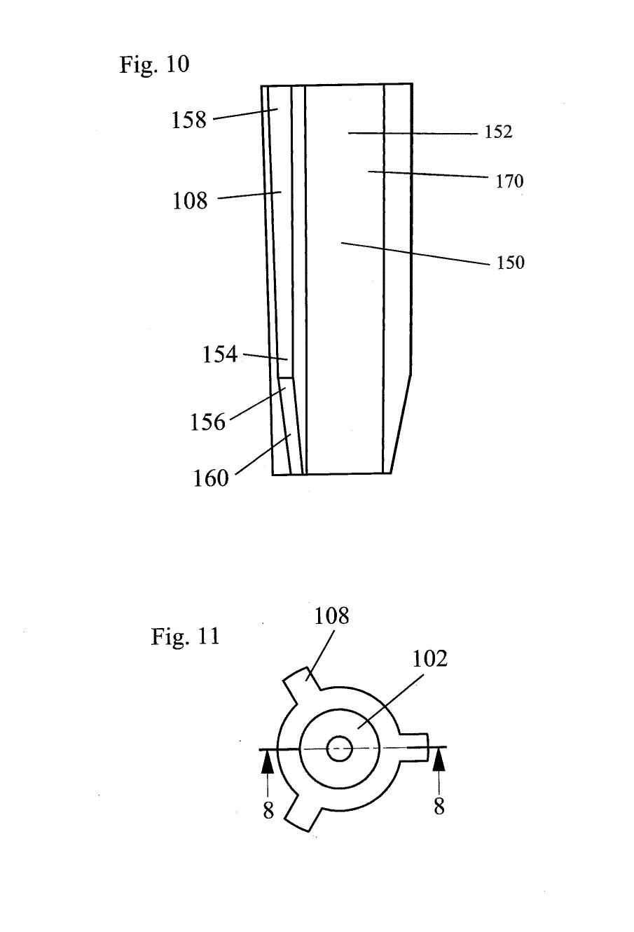

Referring now to FIGS. 8-11 which show isolation tube 100 from various angles including in FIG. 8 a cross-sectional view taken along lines 8-8 of FIG. 11, a bottom side perspective view in FIG. 9, a side plan elevational view in FIG. 10, and a top plan view in FIG. 11.

The reader will note that isolation tube 100 includes a more or less cylindrical body 150 comprised of isolation tube walls 152 and having three projections therein namely wings 108 projecting outwardly from the outer surface 170 of isolation tube 100.

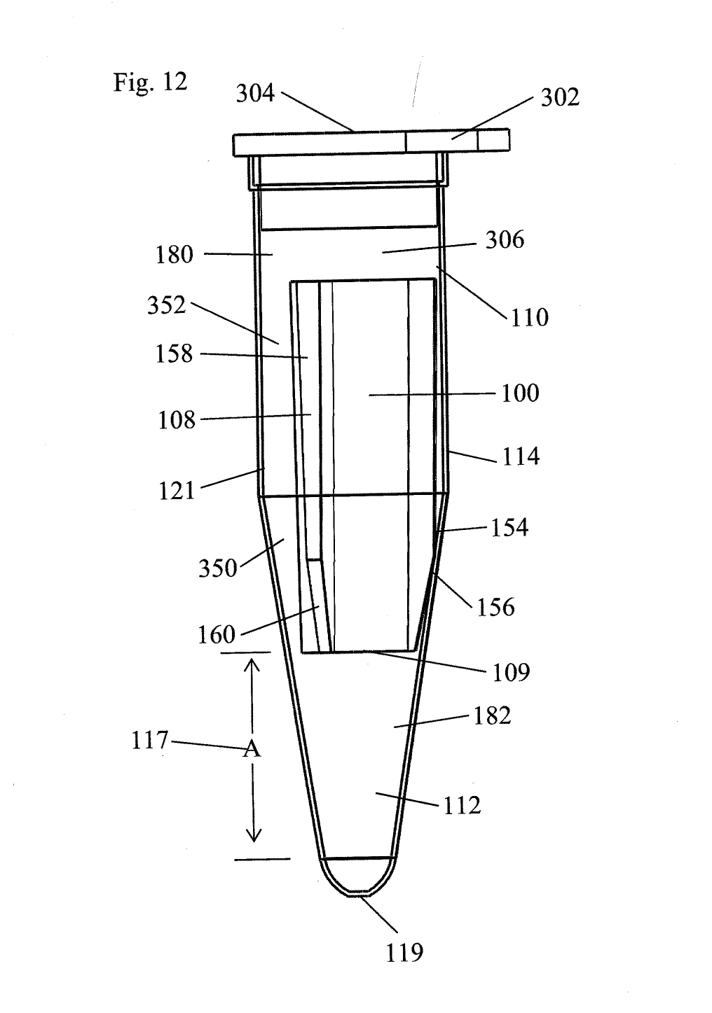

Isolation tube 100 further includes a lumen 102 having a cylindrical lumen section 192 a conical lumen section 190, a bottom diameter 106, a top diameter 104, and a bottom orifice 107. Wings 108 are divided into upper wing section 158 and tapered wing section 160 both of which include an abutment area namely upper abutment area 154 and lower abutment area 156. Referring now also to FIGS. 12-17 which depict an Microcentrifuge or a microcentrifuge tube 110 made of a transparent material such that one is able to see through the wall of the Microcentrifuge tube 110 and view the interior contents.

Microcentrifuge tube 110 includes a cylindrical section 180, a lower tapered section 182 which terminates near the bottom reservoir 112. Microcentrifuge tube 110 further includes a wall 114 with interior surface 121, lid 302 having a lid top 304. This defines a microcentrifuge tube cavity 306 which as indicated before a standard Microcentrifuge tubes may have an interior volume of approximately 1.5 ml.

Show deployed within the microcentrifuge cavity 306 is an isolation tube 100 showing the lower abutment area 156 of wings 108 and the upper abutment area 154 of wings 108 which more or less make contact with the interior surface 121 of walls 114 of microcentrifuge tube 110.

In practice, lower abutment areas 156 of wings 108 make contact with the interior surface 1212 of wall 114 of the tapered sections 182 and the upper abutment areas 154 make contact with the upper cylindrical section 180 of microcentrifuge tube 110 so that bottom 109 of isolation tube 100 is a pre-selected capture distance 117 from bottom 119 of the Microcentrifuge tube.

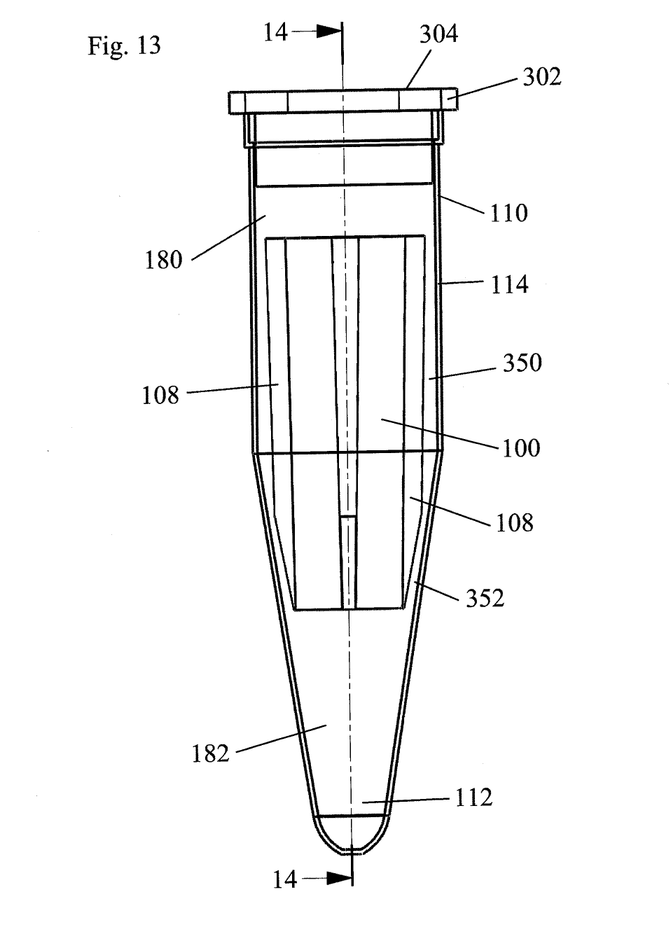

FIG. 13 shows isolation tube 100 from such a view that one is able to view all three wings in this particular view. The drawings for the purpose of clarity show a lower gap of 350 between isolation tube 100 and wall 114 of the Microcentrifuge tube 110 as well as an upper gap 352 both of which are exaggerated for the purpose of being able to better visualize the positioning of the isolation tube 100 within the microcentrifuge tube 110.

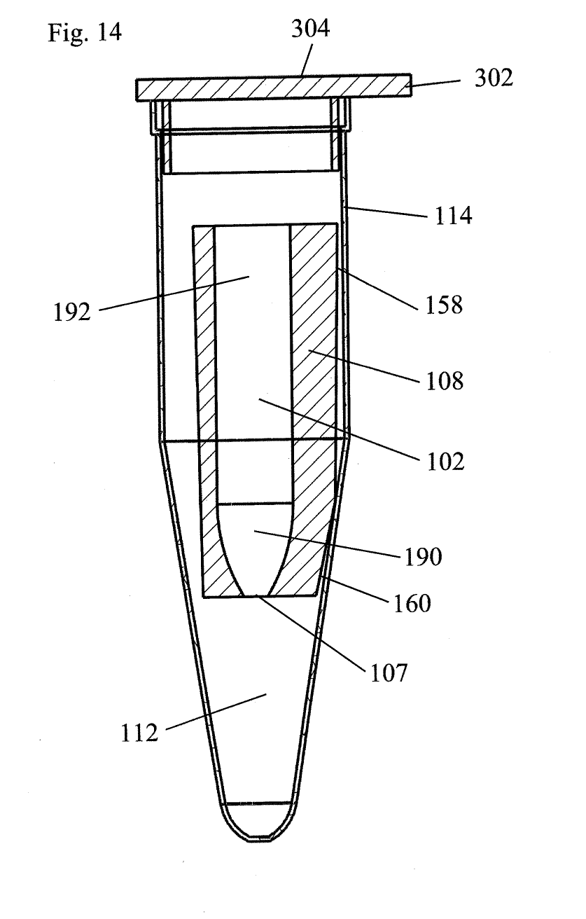

FIG. 14 shows the isolation tube 100 in a cross-sectional view taken along the line 14-14 shown in FIG. 13 wherein the cross section is only taken through one wing which is shown in the right-hand portion of the isolation tube 100.

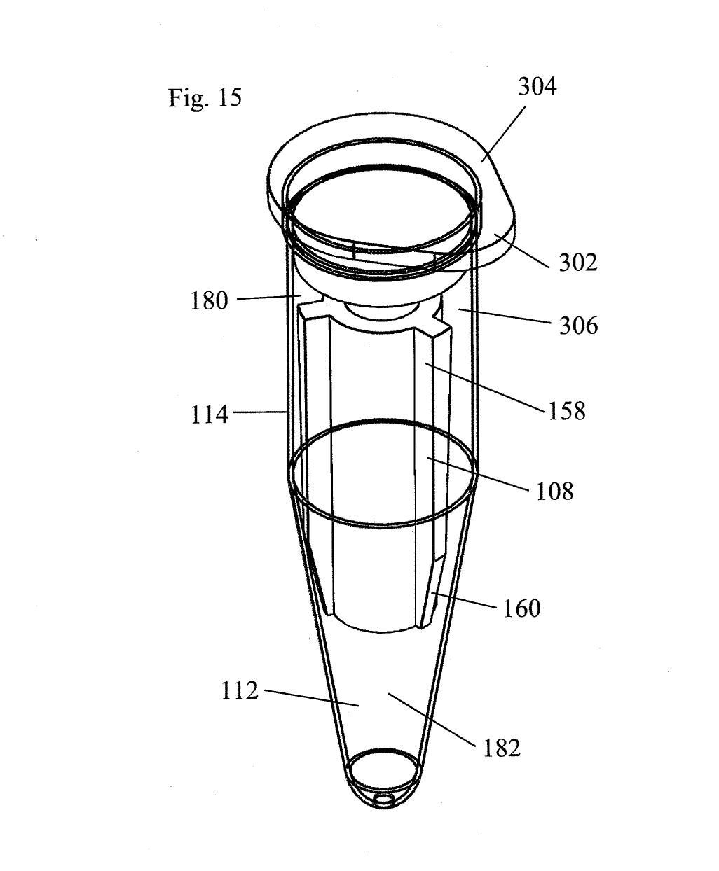

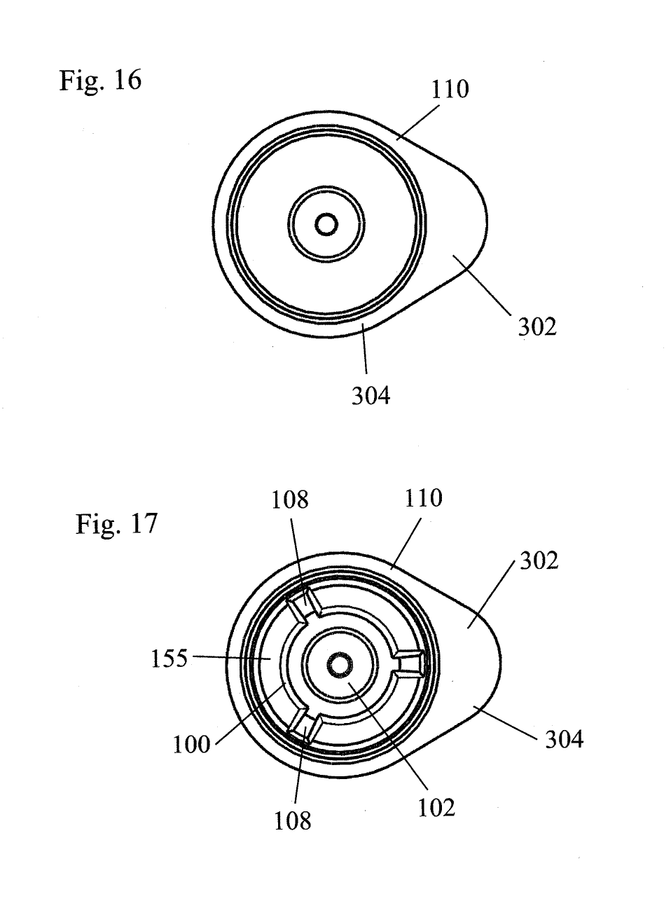

FIG. 15 shows schematically the Microcentrifuge tube 110 in a transparent fashion with the isolation tube 100 positioned within the Microcentrifuge tube. FIG. 16 depicts a top end view of an empty Microcentrifuge tube 110 and FIG. 17 shows an isolation tube 100 in use with Microcentrifuge tube 110 wherein gap 155 between wall 114 and isolation tube 100 can be seen between wings 108.

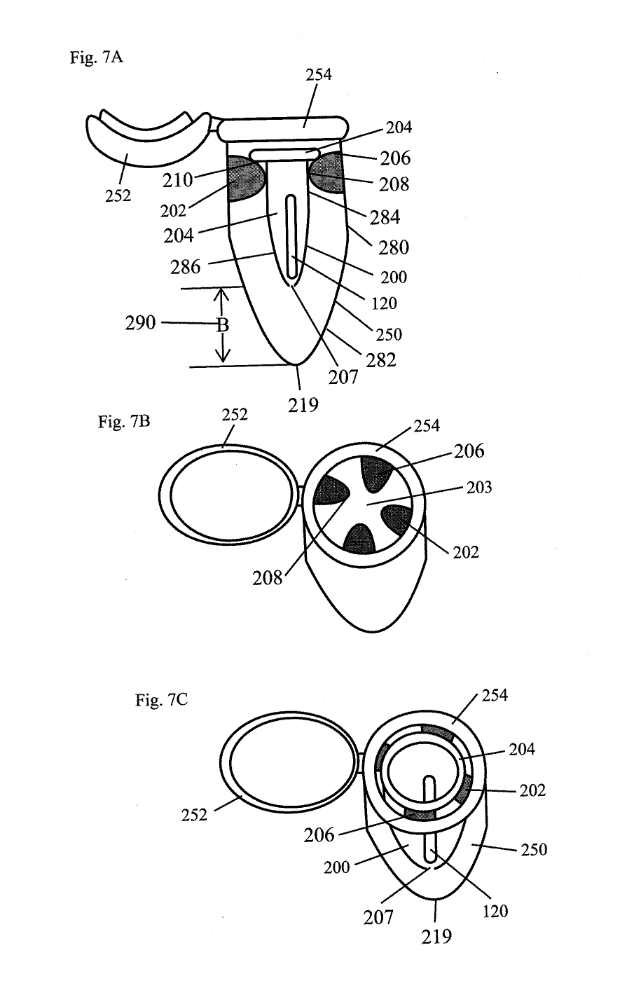

Referring to FIGS. 7A, 7B, and 7C, 7A shows schematically an alternate embodiment namely a microcentrifuge tube 250 having a lid 252, lid collar 254, upper cylindrical section 280, support members 202 shown in grey color, lower tapered section 282 and reservoir 212.

FIGS. 7A and 7C show isolation tube 200 deployed in microcentrifuge tube 250 wherein isolation tube 200 includes an upper cylindrical lumen section 284 and a lower conical lumen section 286 and an upper flange 204 which rests upon support members 202 holding it institute within microcentrifuge tube 250. Furthermore, a bone 120 is also shown within the lumen 204 of isolation tube 200.

FIG. 7B shows a top schematic perspective view of the alternate embodiment namely the microcentrifuge tube 250 shown in FIG. 7A with the lid 252 off to one side wherein one can see the support members 202 projecting inwardly thereby creating an insertion space 203 for receiving isolation tube 200 therein.

FIG. 7C shows schematically in top perspective view an isolation tube 200 deployed within microcentrifuge tube 250 of the alternate embodiment wherein the upper flange 204 of isolation tube 200 is supported by support members 202 holding the isolation tube 200 in the position shown with a bone 120 within its lumen 204. Bone marrow cells exit isolation 200 through orifice 207 during centrifuging and are collected in reservoir 212.

In Use

Bone 120 is cleaned and inserted in lumen 102 of bone marrow isolation tube 100 which is then inserted inside microcentrifuge tube 110. Liquid media 124 in the form of PBS, RBC lysis buffer or other relevant media is added to reservoir 112 of microcentrifuge tube 110 so that bone marrow cells 122 are collected in liquid media 124.

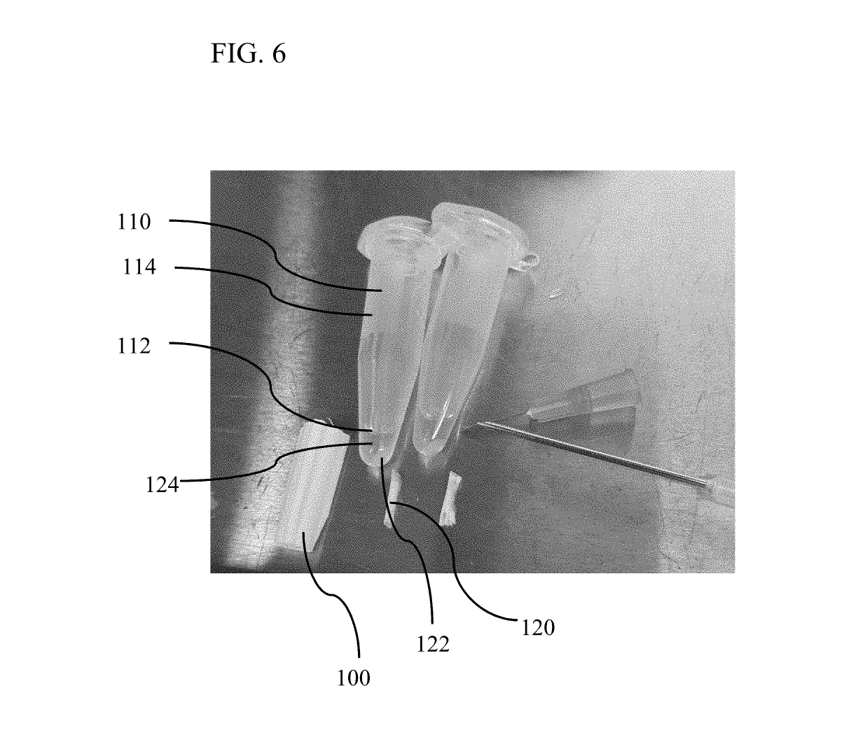

The whole assembly which includes cleaned bone 120, bone marrow isolation tube 100, and liquid media 124 inside microcentrifuge tube 110 is then centrifuged at approximately 1,000-10,000 rpm for the amount of time that the centrifuge machine needs to reach the required speed before stopping the centrifuge machine. Bone marrow cells 122 will be collected in reservoir 112 of Microcentrifuge tube 110, having passed through orifice 107 of bone marrow isolation tube 100 during centrifugation (See FIG. 6).

In the alternate embodiment depicted in FIG. 7 A-C, the isolation tube 200 is wedged into insertion space 203 by contact between bottom flange surface 210 on the isolation tube 200 and upper abutment area 206 of the support members 202 as well as contact between the wall 260 at upper cylindrical lumen section 284 of isolation tube 200 and insertion abutment section 208 of the support members 202. Isolation tube 200 is held in insertion space 203 such that orifice 207 is at a pre-selected capture distance 290 from bottom 219.

There are several advantages to using the present device and method. First, there are considerable time savings as the flushing step of the conventional method is completely eliminated. Isolation of 30 bone marrows takes maximum 5 minutes once the bones are cleaned as the user is simply required to place the cleaned bones in individual bone marrow isolation tubes instead of flushing each bone individually with a needle and saline. It takes approximately 3 hours to isolate 30 bone marrows if the traditional method with flushing step is used.

Furthermore, when traditional methods with the flushing step are used, use of needles poses a risk of accidental poking or skin puncture. It can be especially risky if the user is handling infected mice bones or bone marrows. The present invention does not have any sharp edges and requires minimal contact between infected bone marrows and the user. Disposal is safer, requiring no sharps container or sharps program for disposal.

The present invention has been shown to provide similar results in terms of CD45-a marker of hematopoietic cells, myelo-erythroid progenitors and rate of cell death when compared to traditional methods.

It should be apparent to persons skilled in the arts that various modifications and adaptation of this structure described above are possible without departure from the spirit of the invention the scope of which defined in the appended claim.

I claim:

1. In combination a bone marrow isolation tube and a centrifuge tube, the combination includes:
A) a centrifuge tube which defines a tube cavity which has an interior surface and includes an upper cylindrical section, connected to a lower tapered section which terminates at a bottom reservoir;
B) an isolation tube adapted to be received within the centrifuge tube cavity;
C) the isolation tube includes a body with a tubular shaped outer surface wherein the interior of the isolation tube defines a lumen which includes an upper cylindrical lumen section and a lower conical lumen section terminating at an orifice;
D) the isolation tube includes at least one wing extending radially outward from the outer surface of the isolation tube wherein the wing is configured to make contact with the interior surface of the centrifuge tube thereby contacting and wedging the isolation tube into the tapered section of the centrifuge tube during centrifuging.

2. The combination claimed in claim 1 wherein the wing includes an upper wing section for contacting with the upper cylindrical section of the centrifuge tube, and a lower tapered wing section adapted to wedge and contact with the interior surface of the lower tapered section of the centrifuge tube thereby maintaining the isolation tube at a pre-selected capture distance from a centrifuge tube bottom.

3. The combination claimed in claim 1 wherein the wing includes an upper abutment area for contacting with the upper cylindrical section of the centrifuge tube, and a lower abutment area for contacting with the lower tapered section of the centrifuge tube thereby maintaining the isolation tube at a pre-selected capture distance from a centrifuge tube bottom.

4. The combination claimed in claim 2 wherein the upper wing section includes an upper abutment area for contacting with the upper cylindrical section of the centrifuge tube, and the lower tapered wing section includes a lower abutment area for contacting with the interior surface of the lower tapered section of the centrifuge tube thereby maintaining the isolation tube at a pre-selected capture distance from a centrifuge tube bottom.

5. The combination claimed in claim 2 wherein the isolation tube includes at least three identical wings spaced around the outer surface of the isolation tube thereby providing three lower abutment areas for contacting and wedging the isolation tube into the tapered section of the centrifuge tube during centrifuging.

6. The combination claimed in claim 2 wherein the orifice is dimensioned to allow bone marrow cells to pass through but not cortical bone.

7. The combination claimed in claim 2 wherein the capture distance is selected to hold the bone marrow cells and any liquid media.

8. The combination claimed in claim 2 wherein the isolation tube received within the tube cavity of the centrifuge tube defines a gap between the outer surface of the isolation tube and the interior surface of the centrifuge tube.

9. In combination a bone marrow isolation tube and a centrifuge tube, the combination includes:
A) a centrifuge tube which defines a tube cavity which has an interior surface and includes at least two support members defining an insertion space and attached to the interior surface in an upper cylindrical section, the upper cylindrical section connected to a lower tapered section which terminates at a bottom reservoir;
B) an isolation tube adapted to be received within the insertion space;
C) the isolation tube includes a body with a tubular shaped outer surface wherein the interior of the isolation tube defines a lumen which includes an upper cylindrical lumen section and a lower conical lumen section terminating at an orifice;
D) the isolation tube includes a flange above the upper cylindrical section wherein the flange is configured to make contact with the support members of the centrifuge tube thereby contacting and wedging the isolation tube into the insertion space of the centrifuge tube during centrifuging.

10. The combination claimed in claim 9 wherein the flange includes a bottom flange surface that rests on an upper abutment section of the support members and walls at the upper cylindrical lumen section that contact with an insertion abutment section of the support members adapted to wedge the isolation tube in insertion space thereby maintaining the orifice at a pre-selected capture distance from a centrifuge tube bottom.

11. The combination claimed in claim 9 wherein the centrifuge tube includes four identical support members spaced around the interior surface of the upper cylindrical section thereby providing four upper abutment sections and four insertion abutment sections for contacting and wedging the isolation tube into the insertion section of the centrifuge tube during centrifuging.

12. The combination claimed in claim 9 wherein the orifice is dimensioned to allow bone marrow cells to pass through but not cortical bone.

13. The combination claimed in claim 10 wherein the capture distance is selected to hold the bone marrow cells and any liquid media.
